(19) United States
(12) Patent Application Publication
(10) Pub. No.: US 2006/0119569 A1
(43) Pub. Date: Jun. 8, 2006

(54) Wireless instruction device for a computer-based visual presentation system

(76) Inventor: Huo-Lu Tsai, Taichung Hsien (TW)

Correspondence Address: PITNEY HARDIN LLP, 7 TIMES SQUARE, NEW YORK, NY, 10036-7311, US

(21) Appl. No.: 11/005,769

(22) Filed: Dec. 7, 2004

(51) Int. Cl. G09G 5/00

(52) U.S. Cl. 345/156

(57) ABSTRACT

A wireless instruction device includes a cursor control unit mounted to a rectangular main housing, and a wireless signal transmitter mounted in the main housing. A wireless signal receiver module has a connecting side connected detachably to an engaging first side surface of the main housing. Top and bottom surfaces of the main housing are respectively coplanar with opposite first and second side surfaces of the wireless signal receiver module.

### BACKGROUND OF THE INVENTION

1. Field of the Invention

The invention relates to a wireless instruction device, more particularly to a wireless instruction device for a computer-based visual presentation system that has a compact size and that is convenient to carry.

2. Description of the Related Art

FIGS. 1 and 2 illustrate a conventional wireless instruction device 6, such as an optical mouse, that is used for a computer-based visual presentation system and that includes a housing 60, a wireless signal transmitter (not shown) mounted in the housing 60, and a wireless signal receiver 7.

The housing 60 has a bottom surface 601 formed with a receiving groove 61, and a plug-mounting seat 62 mounted pivotably in the receiving groove 61. The wireless signal receiver 7 has a receiver body 71 and a plug end portion 72 that is connected pivotally to the receiver body 71 when the plug end portion 72 is inserted into the plug-mounting seat 62. The receiver body 71 is pivotable relative to the housing 60 so as to engage the receiving groove 61. The housing 60 further has an engaging member 63 that is biased to engage the receiver body 71 when the receiver body 71 is received in the receiving groove 61 and that is operable so as to enable the receiver body 71 to move away from the receiving groove 61. However, the conventional wireless instruction device 6 has a relatively large volume, thereby resulting in inconvenience when carrying the same.

### SUMMARY OF THE INVENTION

Therefore, the object of the present invention is to provide a wireless instruction device for a computer-based visual presentation system that has a compact size and that is convenient to carry.

According to the present invention, there is provided a wireless instruction device for a computer-based visual presentation system. The wireless instruction device comprises:

a rectangular main housing having opposite top and bottom surfaces, an engaging first side surface, a non-engaging first side surface opposite to the engaging first side surface in a first direction, and a pair of second side surfaces opposite to each other in a second direction transverse to the first direction;

a cursor control unit mounted to the main housing;

a wireless signal transmitter mounted in the main housing and connected to the cursor control unit, the cursor control unit enabling the wireless signal transmitter to transmit a corresponding control signal in response to operation of the cursor control unit; and

a wireless signal receiver module having a connecting side extending in the second direction and connected detachably to the engaging first side surface of the main housing, and first and second side surfaces opposite to each other in a third direction transverse to the first and second directions.

One of the first and second side surfaces of the wireless signal receiver module, and one of the top and bottom surfaces of the main housing are disposed in a first plane. The other one of the first and second side surfaces of the wireless signal receiver module, and the other one of the top and bottom surfaces of the main housing are disposed in a second plane parallel to the first plane.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of a conventional wireless instruction device;

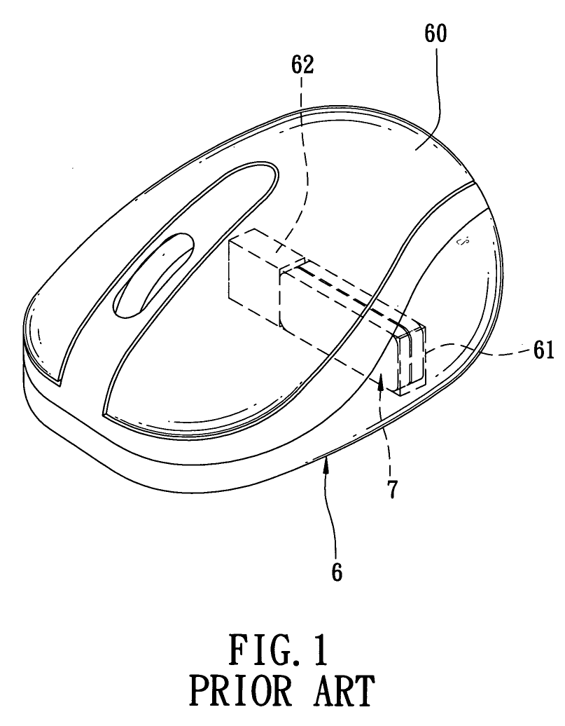

FIG. 2 is a partly exploded perspective view of the conventional wireless instruction device of FIG. 1;

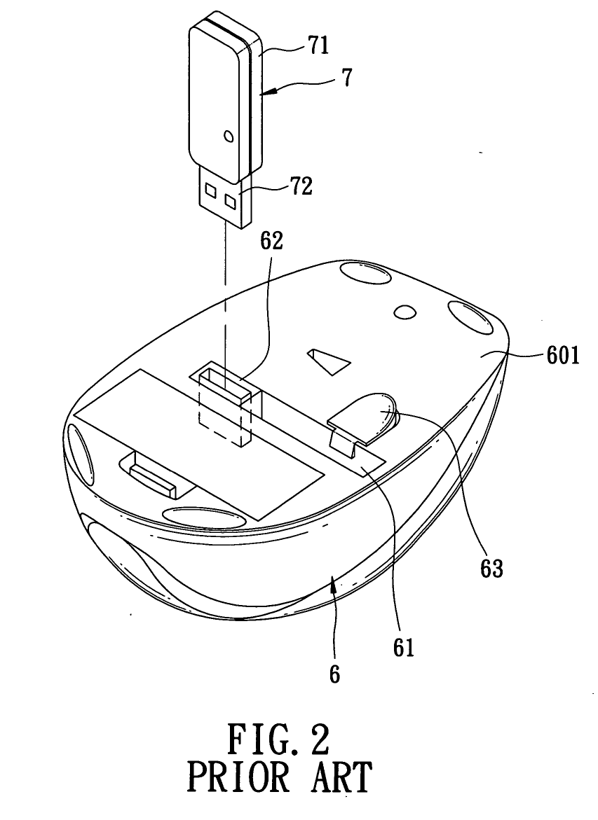

FIG. 3 is a partly exploded perspective view showing the preferred embodiment of a wireless instruction device according to the present invention;

FIG. 3A is an assembled perspective view showing the preferred emodiment;

FIG. 4 is a schematic circuit block diagram illustrating the preferred embodiment;

FIG. 5 is a schematic top view showing the preferred embodiment;

FIG. 6 is a schematic top view showing a wireless signal receiver module of the preferred embodiment when a casing thereof is disposed at an unused position;

FIG. 7 is a perspective view showing the wireless signal receiver module of the preferred embodiment and illustrating movement and rotation of the casing relative to a coupling frame; and

FIG. 8 is a perspective view showing the wireless signal receiver module of the preferred embodiment when the casing is disposed at the used position.

### DETAILED DESCRIPTION OF THE PREFERRED EMBODIMENT

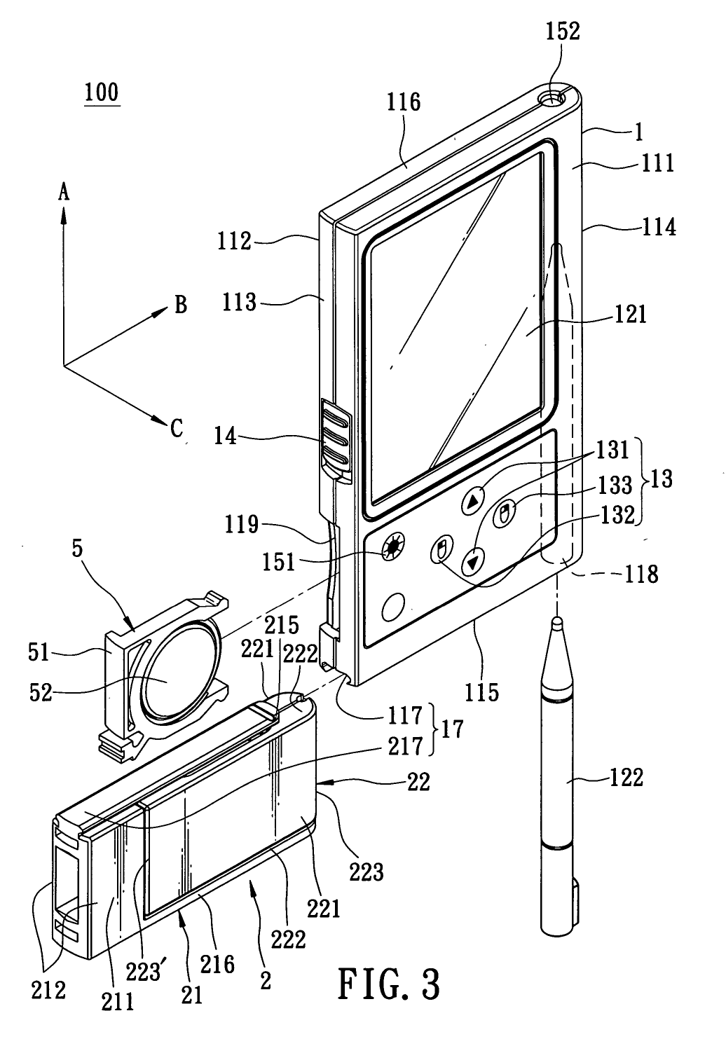

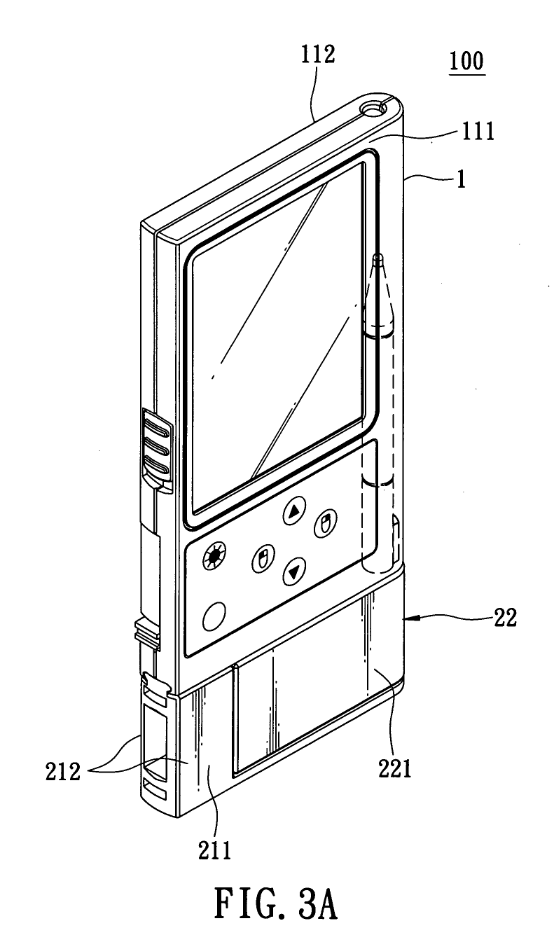

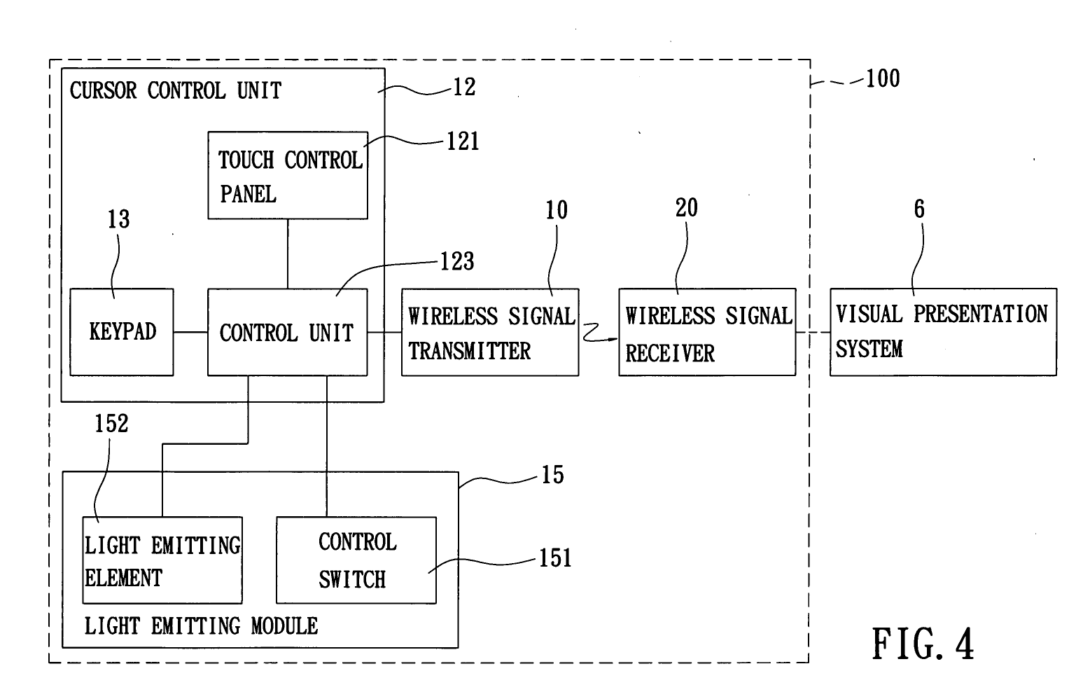

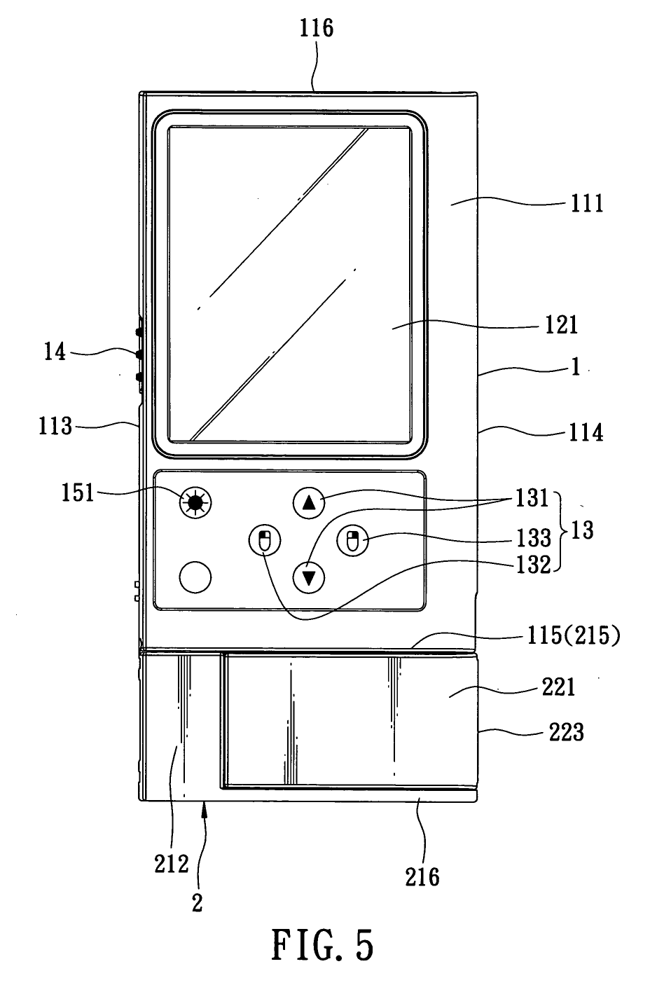

Referring to FIGS. 3 to 5, the preferred embodiment of a wireless instruction device 100 according to the present invention is adapted for use with a computer-based visual presentation system 6, and is shown to include a rectangular main housing 1, a cursor control unit 12, a wireless signal transmitter 10, a light emitting module 15, and a wireless signal receiver module 2.

The main housing 1 has opposite top and bottom surfaces 111, 112, an engaging first side surface 115, a non-engaging first side surface 116 opposite to the engaging first side surface 115 in a first direction (A), and a pair of second side surfaces 113, 114 opposite to each other in a second direction (B) transverse to the first direction (A). In this embodiment, the engaging first side surface 115 of the main housing 1 is formed with a pen-receiving blind hole 118.

The light emitting module 15 includes a light emitting element 152 mounted on the non-engaging first side surface 116, and a control switch 151 mounted on the top surface of the main housing 1 for controlling light emitting activity of the light emitting element 152.

In this embodiment, the cursor control unit 12 includes a touch control panel 121 mounted on the top surface of the main housing 1, a touch pen 122 inserted into the pen-receiving blind hole 118 in the engaging first side surface 115 of the main housing 1, a keypad 13 mounted on the top surface 111 of the main housing 1, and a control unit 123. In this embodiment, the keypad 13 includes a plurality of cursor control keys 131 associated with control of cursor movement, and first and second function keys 132, 133 associated with a Click/Select command and a Context Menu/Alternate Select command for the visual presentation system 6, respectively. The control unit 123 is mounted in the main housing 1, and is connected to the touch control panel 121, the keypad 13, and the light emitting element 152 and the control switch 151 of the light emitting module 15.

The wireless signal transmitter 10 is mounted in the main housing 1, and is connected to the control unit 123. The control unit 123 enables the wireless signal transmitter 10 to transmit a corresponding control signal in response to operation of the keypad 13 or the touch control panel 121 in a known manner.

As best shown in FIGS. 3, 4 and 7, the wireless signal receiver module 2 includes a coupling frame 21, a casing 22, and a wireless signal receiver 20.

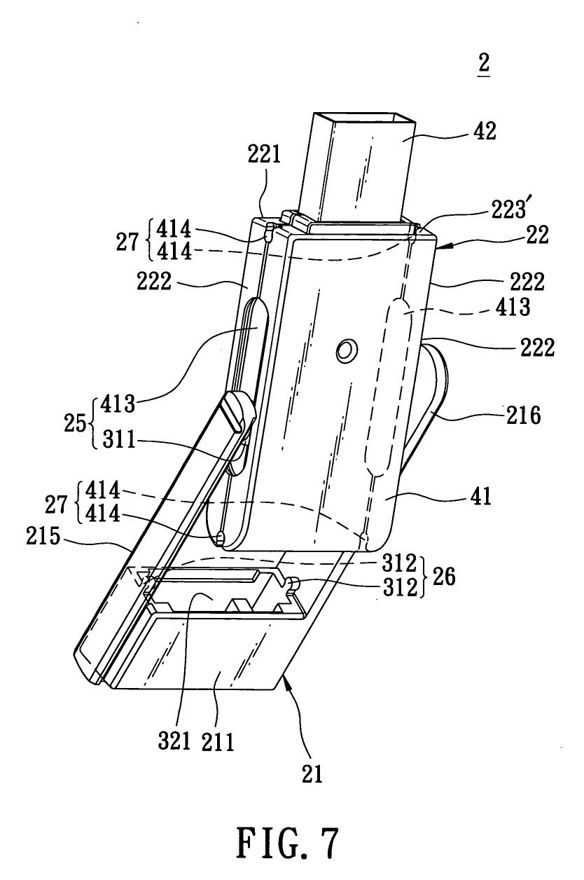

In this embodiment, the coupling frame 21 has a first arm portion 215 extending in the second direction (B) and connected detachably to the engaging first side surface 115 of the main housing 1, a second arm portion 216 parallel to the first arm portion 215 and opposite to the first arm portion 215 in the first direction (A), and an interconnecting block 211 that interconnects the first and second arm portions 215, 216 fixedly, that has two first surfaces 212 opposite to each other in a third direction (C) transverse to the first and second directions (A, B), and that cooperates with the first and second arm portions 215, 216 so as to define a receiving space 24 there among, as shown in FIG. 7. In this embodiment, the interconnecting block 211 is further formed with a plug-receiving groove 321, as best shown in FIG. 7.

In this embodiment, the casing 22 is mounted movably in the receiving space 24 in the coupling frame 21, and has two second surfaces 221 opposite to each other in the third direction (C), two first side surfaces 222 opposite to each other in the first direction (A), and two second side surfaces 223, 223′ opposite to each other in the second direction (B), as best shown in FIG. 3. The second side surface 223′ of the casing 22 is formed with a plug portion 42, which includes a Universal Serial Bus (USB) connector in this embodiment.

The wireless signal receiver 20 is mounted in the casing 22, is adapted to be connected to the visual presentation system 6, and is operable so as to receive the control signal transmitted by the wireless signal transmitter 10 and so as to provide the control signal to the visual presentation system 6.

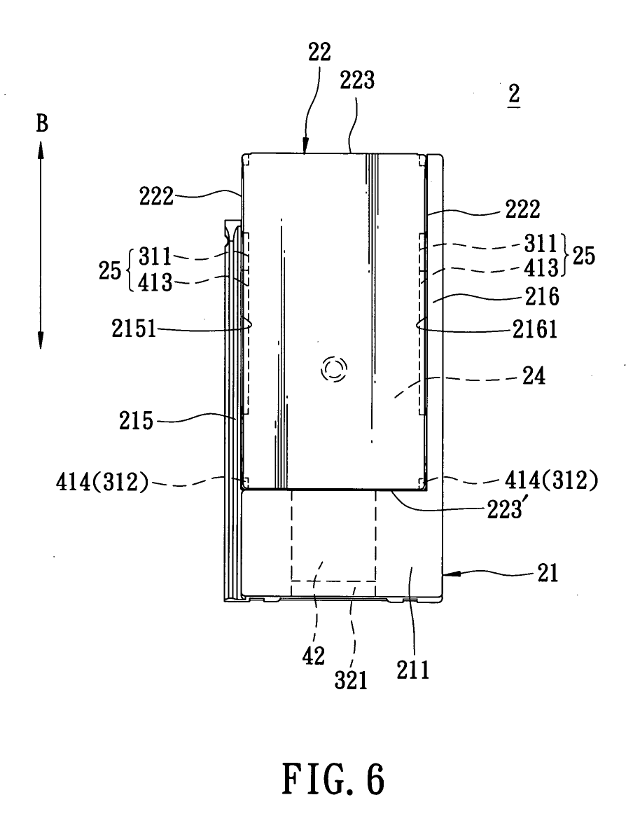

The wireless signal receiver module 2 further includes two engaging units 25 in this embodiment. Each of the first and second arm portions 215, 216 has an inner side surface 2151, 2161 facing a respective one of the first side surfaces 222 of the casing 22. Therefore, the inner side surface 2151, 2161 of each of the first and second arm portions 215, 216 is connected to a corresponding one of the first side surfaces 222 of the casing 22 by means of a corresponding one of the engaging units 25. Each engaging unit 25 includes a slide slot 413 that is formed in the corresponding one of the first side surfaces 222 of the casing 22 and that extends along the second direction (B), and a pivot pin 311 that is formed on the inner side surface 2151, 2161 of the corresponding one of the first and second arm portions 215, 216 and that is received movably within the slide slot 413, as best shown in FIG. 6.

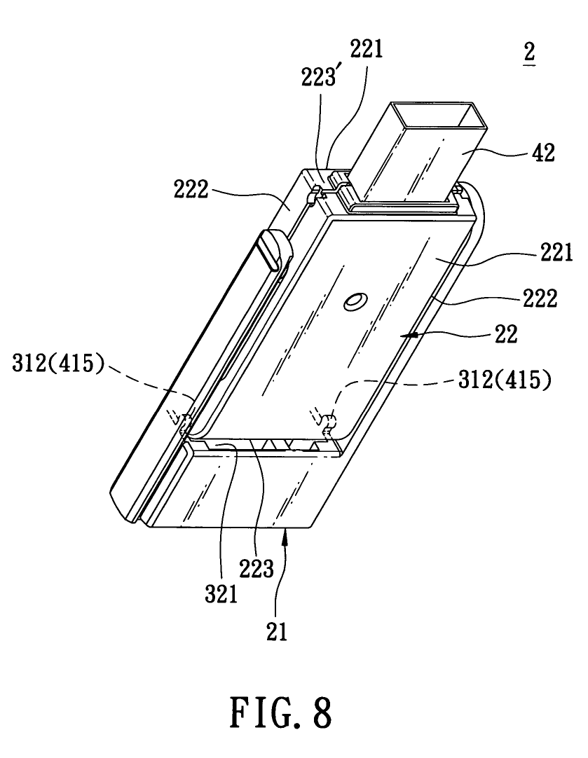

As such, the casing 22 is movable between an unused position, where the plug portion 42 of the casing 22 is received within the plug-receiving groove 321 in the interconnecting block 211, as shown in FIG. 6, and a used position, where the plug portion 42 of the casing 22 is disposed outwardly of the plug-receiving groove 321 in the interconnecting block 211, as shown in FIG. 8.

As best shown in FIG. 7, the wireless signal receiver module 2 further includes a positioning unit that includes a projection unit 26 formed on the interconnecting block 211, and two notch units 27 formed respectively in the second side surfaces 223, 223′ of the casing 22. The projection unit 26 engages the notch unit 27 in the second side surface 223′ of the casing 22 when the casing 22 is disposed at the unused position, thereby positioning the casing 22 in the unused position, as shown in FIG. 6. On the other hand, the projection unit 26 engages the notch unit 27 in the second side surface 223 of the casing 22 when the casing 22 is disposed at the used position, thereby positioning the casing 22 in the used position, as shown in FIG. 8. In this embodiment, as best shown in FIG. 7, the projection unit 26 includes two projections 312 each formed on a juncture between the interconnecting block 211 and a respective one of the first and second arm portions 215, 216. Each notch unit 27 includes two notches 414 each formed in a juncture between a respective one of the second side surfaces 223, 223′ of the casing 22 and a respective one of the first side surfaces 222 of the casing 22. Namely, the notches 414 are disposed respectively at four corners of the casing 22.

As shown in FIG. 3, the wireless instruction device 100 further includes a power supply module that includes a battery set 5 and a power switch 14. The battery set 5 consists of a battery-mounting seat 51 inserted into an insert slot 119 formed in the second side surface 113 of the main housing 1, and a battery 52 mounted in the battery-mounting seat 51 for supplying electric power. The power switch 14 is mounted on the second side surface 113 of the main housing 1 for controlling supply of the electric power form the battery set 5.

An engaging unit 17 includes a dovetail groove 117 formed in the engaging first side surface 115 of the main housing 1, and a dovetail tongue 217 formed on the first arm portion 215 of the coupling frame 21 and engaging the dovetail groove 117 in the engaging first side surface 115 of the main housing 1 such that the wireless signal receiver module 2 is connected movably and detachably to the main housing 1.

Due to such a configuration, one of the first surfaces 212 of the interconnecting block 211, one of the second surfaces 221 of the casing 22, and one of the top and bottom surfaces 111, 112 of the main housing 1 are disposed in a first plane, and the other one of the first surfaces 212 of the interconnecting block 211, the other one of the second surfaces 221 of the casing 22, and the other one of the top and bottom surfaces 111, 112 of the main housing 1 are disposed in a second plane parallel to the first plane, as shown in FIG. 3A, such that the wireless instruction device 100 of this invention has a compact size, thereby facilitating carrying of the same.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A wireless instruction device for a computer-based visual presentation system, comprising:
a rectangular main housing having opposite top and bottom surfaces, an engaging first side surface, a non-engaging first side surface opposite to said engaging first side surface in a first direction, and a pair of second side surfaces opposite to each other in a second direction transverse to the first direction;
a cursor control unit mounted to said main housing;
a wireless signal transmitter mounted in said main housing and connected to said cursor control unit, said cursor control unit enabling said wireless signal transmitter to transmit a corresponding control signal in response to operation of said cursor control unit; and
a wireless signal receiver module having a connecting side extending in the second direction and connected detachably to said engaging first side surface of said main housing, and first and second side surfaces opposite to each other in a third direction transverse to the first and second directions;
wherein one of said first and second side surfaces of said wireless signal receiver module, and one of said top and bottom surfaces of said main housing are disposed in a first plane, and the other one of said first and second side surfaces of said wireless signal receiver module, and the other one of said top and bottom surfaces of said main housing are disposed in a second plane parallel to the first plane.

2. The wireless instruction device as claimed in claim 1, wherein said wireless signal receiver module includes:
a coupling frame having a first arm portion extending in the second direction and connected detachably to said engaging first side surface of said main housing, a second arm portion parallel to said first arm portion and opposite to said first arm portion in the first direction, and an interconnecting block that interconnects said first and second arm portions fixedly, that has two first surfaces opposite to each other in the third direction transverse to the first and second directions, and that cooperates with said first and second arm portions so as to define a receiving space thereamong;
a casing mounted movably in said receiving space in said coupling frame and having two second surfaces opposite to each other in the third direction and coplanar respectively with said first surfaces of said interconnecting block; and
a wireless signal receiver mounted in said casing, adapted to be connected to the visual presentation system and operable so as to receive the control signal transmitted by said wireless signal transmitter and so as to provide the control signal to the visual presentation system;
one of said first surfaces of said interconnecting block and a coplanar one of said second surfaces of said casing constituting one of said first and second side surfaces of said wireless signal receiver module, the other one of said first surfaces of said interconnecting block and the other one of said second surfaces of said casing constituting the other one of said first and second side surfaces of said wireless signal receiver module.

3. The wireless instruction device as claimed in claim 1, wherein said engaging first side surface of said main housing is formed with a pen-receiving blind hole, said cursor control unit including a touch control panel mounted on said top surface of said main housing, and a touch pen inserted into said pen-receiving blind hole.

4. The wireless instruction device as claimed in claim 3, wherein said cursor control unit further includes a keypad mounted on said top surface of said main housing and including a set of keys, said keys including a plurality of cursor control keys, a first function key and a second function key.

5. The wireless instruction device as claimed in claim 1, further comprising a power supply module that includes a battery set mounted in said main housing for supplying electric power, and a power switch mounted on said main housing for controlling supply of the electric power from said battery set.

6. The wireless instruction device as claimed in claim 1, further comprising a light emitting module including a light emitting element mounted on said non-engaging first side surface of said main housing, and a control switch mounted on said top surface of said main housing for controlling light emitting activity of said light emitting element.

7. The wireless instruction device as claimed in claim 2, further comprising an engaging unit that includes a dovetail groove formed in said engaging first side surface of said main housing, and a dovetail tongue formed on said first arm portion of said coupling frame and engaging said dovetail groove in said engaging first side surface of said man housing.

8. The wireless instruction device as claimed in claim 2, wherein:
said casing has two first side surfaces opposite to each other in the first direction, and two second side surfaces opposite to each other in the second direction, one of said second side surfaces of said casing being formed with a plug portion;
said interconnecting block being formed with a plug-receiving groove;
each of said first and second arm portions having an inner side surface facing a respective one of said first side surfaces of said casing;
said wireless signal receiver module further including two engaging units, said inner side surface of each of said first and second arm portions being connected to the corresponding one of said first side surfaces of said casing by means of a corresponding one of said engaging units, each of said engaging units including a slide slot that is formed in one of the corresponding one of said first side surfaces of said casing and said inner side surface of a corresponding one of said first and second arm portions and that extends along the second direction, and a pivot pin that is formed on the other one of the corresponding one of said first side surfaces of said casing and said inner side surface of the corresponding one of said first and second arm portions and that is received movably within said slide slot;
said casing being movable between an unused position, where said plug portion of said casing is received within said plug-receiving groove in said interconnecting block, and a used position, where said plug portion of said casing is disposed outwardly of said plug-receiving groove in said interconnecting block.

9. The wireless instruction device as claimed in claim 8, wherein said wireless signal receiver module further includes a positioning unit, which includes:
a projection unit formed on said interconnecting block; and
two notch units formed respectively in said second side surfaces of said casing;
said projection unit engaging said notch unit in said one of said second side surfaces of said casing when said casing is disposed at the unused position, said projection unit engaging said notch unit in the other one of said second side surfaces of said casing when said casing is disposed at the used position.

10. The wireless instruction device as claimed in claim 9, wherein said projection unit includes two projections each formed on a juncture between said interconnecting block and a respective one of said first and second arm portion, each of said notch units including two notches each formed in a juncture between a respective one of said second side surfaces of said casing and a respective one of said first side surfaces of said casing.
